(19) United States
(12) Patent Application Publication
(10) Pub. No.: US 2008/0308461 A1
(43) Pub. Date: Dec. 18, 2008

(54) Method for On-Line Removal of Corrosive Components of Transformer Oil

(75) Inventor: Mats Dahlund, Soderbarke (SE)

Correspondence Address: VENABLE LLP, P.O. BOX 34385, WASHINGTON, DC, 20043-9998, US

(73) Assignee: ABB RESEARCH LTD., Zurich (CH)

(21) Appl. No.: 12/159,619

(22) PCT Filed: Dec. 28, 2006
(86) PCT No.: PCT/IB2006/004197

§ 371 Date: Jun. 28, 2008

Related U.S. Application Data
(60) Provisional application No. 60/754,647, filed on Dec. 30, 2005.

(51) Int. Cl. C10G 45/00; C10G 29/00; B01J 19/00

(52) U.S. Cl. 208/209; 208/247; 208/244; 208/246; 422/129

(57) ABSTRACT

A method for removal of corrosive compounds from insulating oil. The insulating oil is exposed to at least one reducing agent.

### CROSS-REFERENCE TO RELATED APPLICATION

This application claims priority to U.S. provisional patent application 60/754,647 filed 30 Dec. 2005.

### FIELD OF THE INVENTION

The present invention relates to removing corrosive components from insulation oil, such as insulation oil in transformers.

### BACKGROUND OF THE INVENTION

Power transformers, distribution transformers and reactors usually include an insulation system consisting of oil and cellulose. These two components have been used for a long time due to their relatively low price and good performance. The dielectric strength of such an insulation system is strongly dependent on its insulating properties.

One problem that occurs with insulating oils used in power transformers, distribution transformers and reactors is copper sulfide, such as copper(I) sulfide, deposits forming on conductors and in solid insulation in transformers. Copper sulfide deposits can lower the initiation level for partial discharges (PD). With deposition in areas of the windings, with high electrical stresses and under certain operating conditions, especially the abundance of transients, PD activity may lead to degradation of the solid insulation and ultimately to dielectric breakdown. In extreme cases copper sulfide growth may be so extensive that conductive bridges are formed through several layers of conductor covering paper. In such cases failures may occur even in the absence of extra-ordinary stresses.

An example of an area where the electrical stress is high is between turns in the windings. This turn-to-turn insulation is typically built up by conductor insulation, which may include paper wrapping, for example, and sometimes also spacers separating the conductors from each other. The conductors may be insulated with paper wrapping. Both the conductor insulation and the spacers will then be very sensitive for copper(I) sulfide deposits.

Problems of copper sulfide formation in transformer insulation has increased in the last ten to fifteen years. This appears to be due at least in part to increased corrosivity of insulating oils. Many transformers are filled with corrosive oil. While new less corrosive oils are being developed, it may take several years for new specifications take effect world wide. Also, it may take years to secure sufficient supplies of harmless oils. As a result, many more transformers and reactors will be filled with corrosive insulting oils. Furthermore, it will take time for cycles of transformer and transformer oil replacement to result in the elimination of corrosive insulating oils.

Reactions leading to copper sulfide formation can be prevented or suppressed by removing or reducing active copper and sulfur containing components. However, conventional insulating oil processing techniques, such as reconditioning and reclaiming have little or no effect. Reclaiming, which is typically carried out by treating the oil with a sorbent for polar contaminants, such as Fullers earth or alumina, has as its primary purpose to remove oxidation products from aged oil, and restore it to a condition similar to that of new oil. Copper mercaptides and other copper-organic compounds can be removed with this process. However, the effect on active sulfur species can vary depending on the process used, and the effect on compounds like mercaptans, sulfides and disulfides can be small.

Such methods can be enhanced by first treating the oil with a sulfur scavenging material to bind the sulfur and/or convert the sulfur into compounds that are more easily removable by the sorbent. Such sulfur scavenging materials can include copper or copper oxide. However, such methods may still not provide satisfactory treatment.

### SUMMARY OF THE INVENTION

One aspect of the present invention provides a method for removal of corrosive compounds from insulating oil. The method includes exposing the insulating oil to at least one reducing agent.

Another aspect of the present invention provides a system for removal of corrosive compounds from insulating oil. The system includes elements for exposing the insulating oil to at least one reducing agent.

Further objectives and advantages, as well as the structure and function of exemplary embodiments will become apparent from a consideration of the description, drawings and examples.

### BRIEF DESCRIPTION OF THE DRAWINGS

The foregoing and other features and advantages of the invention will be apparent from the following, more particular description of an exemplary embodiment of the invention, as illustrated in the accompanying drawings wherein like reference numbers generally indicate identical, functionally similar, and/or structurally similar elements.

FIG. 1 represents a schematic diagram illustrating one embodiment of a system according to the present invention.

### DETAILED DESCRIPTION OF EMBODIMENTS OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention.

The present invention provides methods for improving the removal of corrosive components from insulating oil, such as transformer or reactor oil. The corrosive components can include sulfur organic components. The present invention may act at least in part by converting harmful oil components into easily removed substances. The methods typically are carried out on-line. This can make the present invention easy to carry out since the steps may be added to steps already used in on-line processing. One example of on-line processing that the present invention may be utilized with is described in Experiences From On-Site Transformer Oil Reclaiming, Berg et al., CIGRE, 2002, from the CIGRE 2002 Session Proceedings, the entire contents of the disclosure of which is hereby incorporated by reference.

The step(s) according to methods of the present invention typically are performed as pretreatment steps to steps already carried out in on-line processing. Embodiments of the present invention may include a step of exposing insulating oil to at least one reducing agent. Exposing insulation oil and sulfur compounds in the oil to a reducing agent can convert the sulfur compounds, especially disulfides, to more reactive forms, such as mercaptans, that may react more strongly with a sulfur scavenger. The reduction may also make the sulfur compounds more strongly absorbed by polar sorbent, such as Fuller's earth, alumina or others.

Any suitable reducing agent may be utilized. According to one embodiment zinc is used as a reducing agent. If zinc is used as the reducing agent, the form of the zinc may vary. For example, zinc shavings or granules could be used. The zinc could also be in the form of zinc amalgam. Another type of reducing agent that could be utilized is a metal containing dissolved hydrogen. One form of such metal is Raney nickel, which is a strong reducing agent. Those skilled in the art would know other reducing agents that could be utilized since reducing agents are known compounds.

The insulating oil could be exposed to the reducing agent(s) in a variety of ways. According to one embodiment, the reducing agent could be arranged in a column. The insulating oil could then be passed through the column. Any suitable means may used to carry out exposing the insulating oil to the reducing agent. The column or other apparatus may be attached to existing apparatus for on-line treatment of insulating oil. The oil may be run through one or more columns one or more times. Typically, the oil is run through a treatment system from about 5 to about 20 times. The oil may be tested to determine whether the desired quality has been achieved, such as whether a desired amount of corrosive compounds have been removed. Typically, the amount of reducing agent utilized is sufficient to not need changing before a batch of oil is treated. In some instances the amount of reducing agent utilized in a system is sufficient to treat multiple batches of oil a plurality of times. In some cases, the level of corrosive compounds may be so great that the reducing agent must be changed out prior to achieving a desired level of corrosive compounds.

Prior to exposing the insulating oil to one or more reducing agents, one or more acidic substances may be added to the insulating oil. Adding acid to the insulating oil may increase the reaction rate of the corrosive sulfur compounds with the reducing agent. A variety of acids may be utilized according to the present invention. The acid(s) may be added in pure form or in a solvent. For example, the acid could be dissolved in oil. For example, a stock solution of acetic acid or other carboxylic acid in transformer oil, or acid in pure form could be utilized.

The acid could be added to an oil stream continuously or periodically, as needed. The acid may be added to the oil stream before the oil encounters the reducing agent. The acid(s) may be added to the insulating oil stream as it passes to the column or other equipment for exposing the oil to reducing agent(s).

The amount of acid added may vary according to a number of factors. For example, the amount of acid added may depend upon the amount of corrosive compounds in the oil. More acid may be added if the oil contains more corrosive compounds. According to one example, acid is added to obtain a total acid number in the treated oil of about 0.1 to about 0.5 mg KOH/g.

Also prior to exposing the insulating oil to one or more reducing agents, the insulating oil may be exposed to one or more sulfur scavenging substances.

Whether or not the insulating oil is acidified, after being exposed to the reducing agent(s), the oil may be exposed to at least one mercaptan and/or sulfide scavanger. Examples of mercaptan and/or sulfide scavangers that could be utilized include copper, zinc and/or iron. The copper, zinc and/or iron could be in the form of metal shavings and/or oxide granules.

The insulating oil could be exposed to the at least one mercaptan and/or sulfide scavanger in any suitable manner. For example, the at least one mercaptan and/or sulfide scavanger could be arranged in one or more columns and the insulating oil passed through the column(s) one or more times. The insulating oil may be exposed to the at least one mercaptan and/or sulfide scavanger until the level of mercaptans and/or sulfides drops to an acceptable level. According to one embodiment, the insulating oil may be exposed to the at least one mercaptan and/or sulfide scavanger until the final total content of disulfide and mercaptan sulfur is about 5 mg/kg.

After processing according to the present invention, the insulating oil may be processed according to known on-line processing techniques. For example, the insulating oil may be exposed to one or more polar sorbents, such as Fuller's earth. The oil may also be readdivated. The readivation may include adding one or more oxidation inhibitors to the insulation oil. Also, the readdivating may include adding one or more metal passivators to the insulating oil. Examples of metal passivators that may be employed are those of the triazole or benzotriazole types.

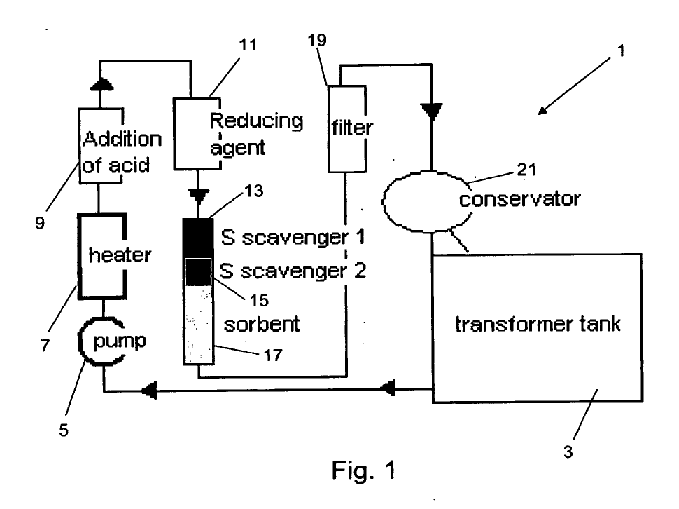

The present invention may also include a system for removing corrosive compounds from insulating oil. FIG. 1 illustrates an embodiment of a system 1 according to the present invention. The oil may be pumped from transformer tank 3 by pump 5. According to this embodiment, the oil is first pumped to a heater 7. Acid may then be added to the oil 9. After adding acid, the oil may be exposed to reducing agent 11. The oil may then be exposed to sulfur scavenger(s) 13 and 15 and sorbent 17. Next, the oil may be filtered 19. Finally, the oil may be returned via the oil conservator 21 to the transformer tank 3. The oil may be moved through the system and/or a portion of the system, such as being exposed to the reducing agent, a plurality of times.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

We claim:

1. A method for removal of corrosive compounds from insulating oil, the method comprising:
exposing the insulating oil to at least one reducing agent.

2. The method according to claim 1, wherein the reducing agent comprises a metal.

3. The method according to claim 2, wherein the metal is zinc.

4. The method accord to claim 3, wherein the zinc comprises at least one of zinc shavings, zinc granules or zinc amalgam.

5. The method according to claim 2, wherein the metal contains dissolved hydrogen.

6. The method according to claim 5, wherein the metal comprises Raney nickel.

7. The method according to claim 1, wherein the reducing agent is arranged in a column and the insulating oil is passed through the column.

8. The method according to claim 1, further comprising:
introducing at least one acidic compound into the insulating oil prior to exposing the insulating oil to the reducing agent.

9. The method according to claim 8, further comprising:
exposing the insulating oil to at least one mercaptan/sulfide scavenger after exposing the insulating oil to the reducing agent.

10. The method according to claim 9, wherein the at least one mercaptan/sulfide scavenger comprises at least one of copper shavings or copper oxide granules.

11. The method according to claim 9, wherein the at least one mercaptan/sulfide scavenger is arranged in a column and the insulating oil is passed through the column.

12. The method according to claim 1, further comprising:
exposing the insulating oil to at least one mercaptan/sulfide scavenger after exposing the insulating oil to the reducing agent.

13. The method according to claim 12, wherein the at least one mercaptan/sulfide scavenger comprises at least one of copper shavings or copper oxide granules.

14. The method according to claim 12, wherein the at least one mercaptan/sulfide scavenger is arranged in a column and the insulating oil is passed through the column.

15. The method according to claim 1, further comprising:
exposing the insulating oil to at least one sulfur scavenging material prior to exposing the insulating oil to the reducing agent.

16. The method according to claim 1, further comprising:
exposing the insulating oil to at least one polar sorbent.

17. The method according to claim 16, wherein the at least one polar sorbent comprises Fuller's earth.

18. The method according to claim 1, further comprising:
readdivating the oil.

19. The method according to claim 18, wherein the readdivating comprises adding at least one oxidation inhibitor to the insulation oil.

20. The method according to claim 19, wherein the readdivating further comprises adding at least one metal passivator to the insulation oil.

21. The method according to claim 20, wherein the at least one metal passivator is of the triazole or benzotriazole type.

22. A system for removal of corrosive compounds from insulating oil, the system comprising:
means to expose the insulating oil to at least one reducing agent.

23. The system according to claim 22, further comprising:
means to introduce at least one acidic compound into the insulating oil prior to exposing the insulating oil to the reducing agent.

24. The system according to claim 22, further comprising:
means to expose the insulating oil to at least one mercaptan/sulfide scavenger after exposing the insulating oil to the reducing agent.
